(19) United States
(12) Patent Application Publication
(10) Pub. No.: US 2016/0248665 A1
(43) Pub. Date: Aug. 25, 2016

(54) PACKET PROCESSING

(71) Applicant: HANGZHOU H3C TECHNOLOGIES CO., LTD., Hangzhou, Zhejiang (CN)

(72) Inventor: Changzhong GE, Beijing (CN)

(73) Assignee: Hangzhou H3C Technologies Co., Ltd., Hangzhou City (CN)

(21) Appl. No.: 15/028,248

(22) PCT Filed: Oct. 9, 2014
(86) PCT No.: PCT/CN2014/088161

§ 371 Date: Apr. 8, 2016

(30) Foreign Application Priority Data
Oct. 10, 2013 (CN) 201310469806.0

(51) Int. Cl. H04L 12/725; H04L 12/927; H04L 29/06

(52) U.S. Cl. CPC H04L 45/302; H04L 63/101; H04L 47/805

(57) ABSTRACT

According to an example, a packet to be processed is compared with a rule in a combined access control list (ACL), wherein the combined ACL includes rules corresponding to different service types.

### BACKGROUND

Access control list (ACL) is a collection of permit and deny conditions, called rules that may classify packets by allowing some packets and blocking the others. The maximum number of rules per ACL is called the capacity of the ACL. Each rule consists of multiple fields and each field includes multiple fields. There are several types of fields and each of them corresponds to a particular matching method. If a key of a packet matches all fields of a rule, it is determined that the packet matches the rule.

### BRIEF DESCRIPTION OF THE DRAWINGS

Features of the present disclosure are illustrated by way of example and not limited in the following figure(s), in which like numerals indicate like elements, in which:

FIG. 1 shows a packet processing method according to various examples of the present disclosure;

FIG. 2 shows a packet processing method according to various examples of the present disclosure;

FIG. 3 shows a packet processing method according to various examples of the present disclosure;

FIG. 4 shows a packet processing method according to various examples of the present disclosure;

FIG. 5 shows a packet processing apparatus according to various examples of the present disclosure;

FIG. 6 shows a packet processing apparatus according to various examples of the present disclosure; and

FIG. 7 shows a packet processing apparatus according to various examples of the present disclosure.

### DETAILED DESCRIPTION

Hereinafter, the present disclosure is described in further detail with reference to the accompanying drawings and examples.

For simplicity and illustrative purposes, the present disclosure is described by referring to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

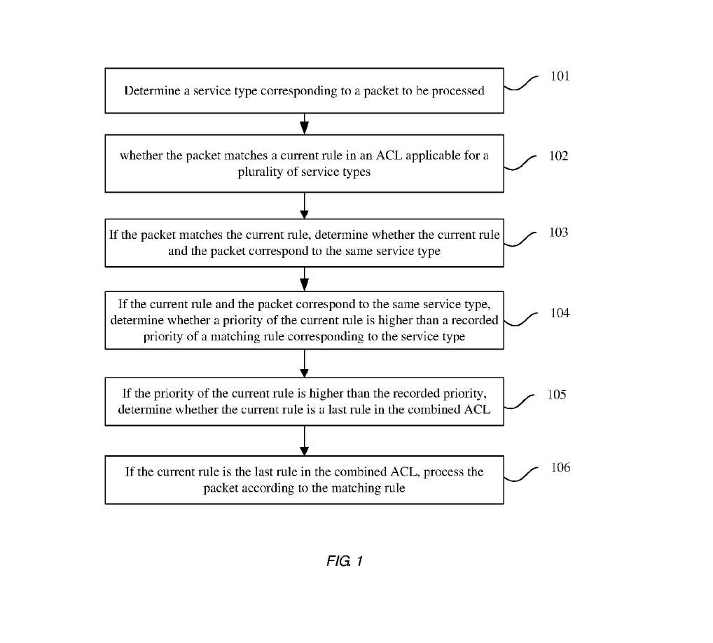

FIG. 1 shows a packet processing method according to various examples of the present disclosure. As shown in FIG. 1, the method includes the following.

At block 101, a service type corresponding to a packet to be processed is determined. The packet to be processed may for example be a packet received by a device in which an ACL is configured.

In various examples, the service type indicates a service processing to be performed to the packet. For example, if a QoS processing is to be performed to the packet, the service type corresponding to the packet is QoS. For another example, if a QoS processing and a packet filtering processing are to be performed to the packet, the service types corresponding to the packet include QoS and packet filtering.

At block 102, it is determined whether the packet matches a current rule in an ACL applicable for a plurality of service types, if the packet matches the current rule, block 103 is executed; otherwise, block 105 is executed.

In this block, the ACL is obtained through combining ACLs respectively applicable for one of the plurality of service types.

At block 103, it is determined whether the current rule and the packet correspond to the same service type, if the current rule and the packet correspond to the same service type, block 104 is executed; otherwise, block 105 is executed.

At block 104, it is determined whether a priority of the current rule is higher than a recorded priority of a matching rule corresponding to the service type, if the priority of the current rule is higher than the recorded priority, the recorded priority is updated with the priority of the current rule, and the current rule is taken as the matching rule corresponding to the service type.

At block 105, it is determined whether the current rule is a last rule in the combined ACL, if yes, block 106 is executed, otherwise, a next rule in the combined ACL is taken as the current rule and the method returns to blocks 102.

At block 106, the packet is processed according to the matching rule.

In various examples, ACLs applicable for a plurality of service types are combined and each rule in the combined ACL is identified with a service type applicable for the rule. Thus, if multiple kinds of service processing are to be performed to a packet, it is not required to search multiple ACLs. The method provided by the examples of the present disclosure is able to obtain matching rules corresponding to a plurality of service types through searching the combined ACL for just one time. Thus, the searching efficiency is increased.

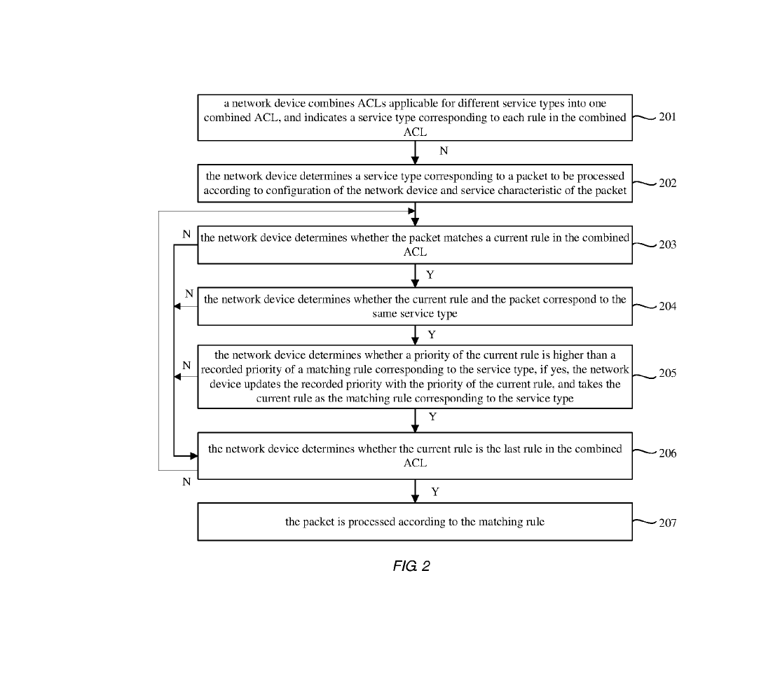

FIG. 2 shows a packet processing method according to various examples of the present disclosure. As shown in FIG. 2, the method includes the following.

At block 201, a network device combines ACLs applicable for different service types into one combined ACL, and indicates a service type corresponding to each rule in the combined ACL.

In various examples, the network device may be any device in which an ACL is configured, such as a router. Each ACL includes a collection of rules. When the ACLs applicable for different service types are combined, the rules in each ACL are put in one combined ACL. If there are the same rules applicable for several service types, these rules may be combined into one rule. The ACL may for example be stored on a non-transitory machine readable medium of the device.

In various examples, a service field is configured for each rule in the combined ACL to indicate the service type corresponding to the rule. Each bit of the service field corresponds to one service type. The value of the bit indicates whether the rule is applicable for the corresponding service type.

For example, suppose that there are four ACLs in one network device. Each ACL corresponds to one service type. The four service types include: PBR, QoS, packet filter, and NAT. The four ACLs are combined into one ACL.

In various examples, a service field including four bits is introduced for each ACL rule to indicate the service type(s) applicable for the rule. Each bit of the service field represents one service type. For example, bit 3 represents whether the rule is applicable for PBR, bit 2 represents whether the rule is applicable for QoS, bit 1 represents whether the rule is applicable for packet filter, and bit 0 represents whether the rule is applicable for NAT. For example, if the service field of a rule is 1100, it indicates that the rule is applicable for the PBR and the QoS.

At block 202, the network device determines a service type corresponding to a packet to be processed according to configuration of the network device and service characteristic of the packet.

In various examples, the service type corresponding to the packet denotes the service processing to be performed to the packet. For example, if the PBR and QoS service processing are to be performed to the packet, service types corresponding to the packet are PBR and QoS.

Similarly as block 201, a service field may be configured for the packet to indicate the service type corresponding to the packet. For example, the service field includes four bits, wherein each bit indicates whether a service type is enabled for the packet. In various examples, bit 3 represents whether PBR is enabled, bit 2 represents whether QoS is enabled, bit 1 represents whether packet filter is enabled, and bit 0 represents whether NAT is enabled.

For example, PBR and QoS processing are to be performed to a particular packet. Thus, it is determined that the service field corresponding to the packet is 1100.

At block 203, the network device determines whether the packet matches a current rule in the combined ACL; if the packet matches the current rule; block 204 is executed; otherwise, block 206 is executed.

At block 204, the network device determines whether the current rule and the packet correspond to the same service type, if yes, block 205 is executed; otherwise, block 206 is executed.

In various examples, the service field of the rule and the service field of the packet may be compared. If the service fields of both the rule and the packet indicate that a particular service type is enabled, it is determined that the current rule and the packet correspond to the same service type.

For example, suppose that the service field of the packet is 1100, i.e. the service types corresponding to the packet include PBR and QoS. If the service field of a rule is 1000, 0100 or 1100, it is determined that the rule corresponds to the same service type with the packet. If the service field of the rule is other than 1000, 0100 and 1100, it is determined that the rule does not correspond to the same service type with the packet.

At block 205, the network device determines whether a priority of the current rule is higher than a recorded priority of a matching rule corresponding to the service type, if yes, the network device updates the recorded priority with the priority of the current rule, and takes the current rule as the matching rule corresponding to the service type.

For a service type, after the network device first time finds a matching rule, referred to as a first rule, the network device records an index and a priority of the first rule, and takes the first rule as a matching rule corresponding to the service type. Thereafter, if another matching rule is found, referred to as a second rule, it is determined whether the priority of the second rule is higher than the recorded priority of the first rule. If higher, the recorded index and priority of first rule are updated by the index and priority of the second rule, so as to ensure that the recorded priority is always the highest.

In this block, if the priority of the current rule is higher than the recorded priority, the recorded priority is updated with the priority of the current rule. And a recorded index of the matching rule is updated with the index of the current rule. The current rule is taken as the matching rule corresponding to the service type.

If the current rule and the packet have two or more same service types, block 205 is executed respectively with respect to each service type. For example, if the service fields of both the rule and the packet are 1100, i.e., both the rule and the packet correspond to the PBR and the QoS services, the priority of the current rule is respectively compared with recorded priorities of matching rules corresponding to the PBR and QoS services.

In this block, an array may be defined for the packet to record the indexes of the matching rules corresponding to the service types of the packet. Each element in the array indicates the index of a matching rule corresponding to one service type. Initially, the values of the elements in the array may be configured to invalid numbers such as −1, indicating that there is no matching rule yet.

At block 206, the network device determines whether the current rule is the last rule in the combined ACL, if yes, block 207 is executed; otherwise, a next rule in the combined ACL is taken as the current rule and the method returns to block 203.

At block 207, the packet is processed according to the matching rule.

At this time, all of the rules in the ACL have been traversed. The priority of the matching rule finally recorded in the network device is the highest among all rules corresponding to the service type in the ACL. Therefore, the matching rule is determined according to the recorded index. The packet is processed according to the matching rule.

In the examples as shown in FIG. 1 and FIG. 2, the determination on whether the packet match a current rule in the combined ACL (block 203) is made prior to the determination on whether the packet and the current rule correspond to the same service type (block 204).

In various examples, it is also possible to determine whether the packet and the current rule correspond to the same service type before determining whether the packet matches the current rule.

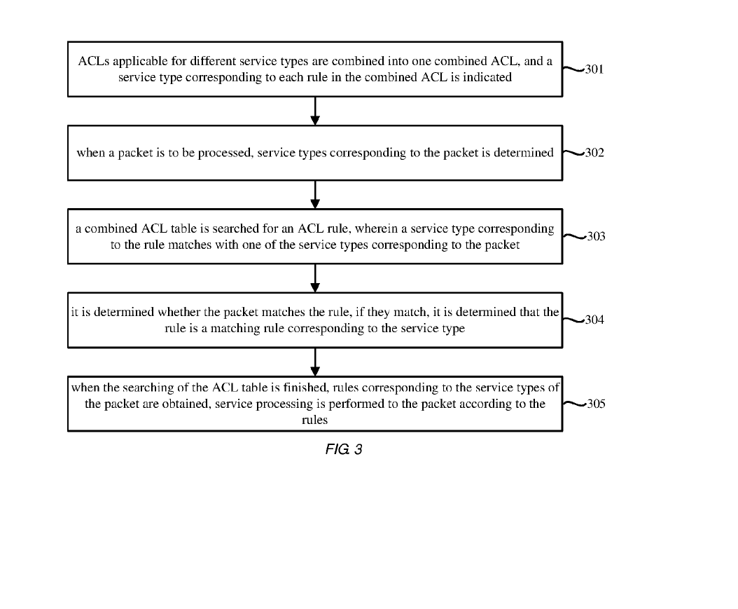

FIG. 3 shows a packet processing method according to various examples of the present disclosure. As shown in FIG. 3, the method includes the following.

At block 301, ACLs applicable for different service types are combined into one combined ACL, and a service type corresponding to each rule in the combined ACL is indicated.

At block 302, when a packet is to be processed, service types corresponding to the packet is determined.

In various examples, the service type indicates a service processing to be performed to the packet. For example, if a QoS processing is to be performed to the packet, the service type corresponding to the packet is QoS. For another example, if a QoS processing and a packet filtering processing are to be performed to the packet, the service types corresponding to the packet include QoS and packet filtering.

At block 303, a combined ACL table is searched for an ACL rule, wherein a service type corresponding to the rule matches with one of the service types corresponding to the packet.

In this block, the combined ACL is obtained through combining a plurality of ACLs respectively applicable for different service types.

At block 304, it is determined whether the packet matches the rule, if they match, it is determined that the rule is a matching rule corresponding to the service type.

At block 305, when the searching of the ACL table is finished, rules corresponding to the service types of the packet are obtained, service processing is performed to the packet according to the rules.

It can thus be seen that after the searching of the ACL is finished, the network device obtains rules corresponding to all service types of the packet. For a packet on which multiple kinds of service processing are to be performed, it just requires searching the combined ACL for one time to obtain the matching rule corresponding to each service type.

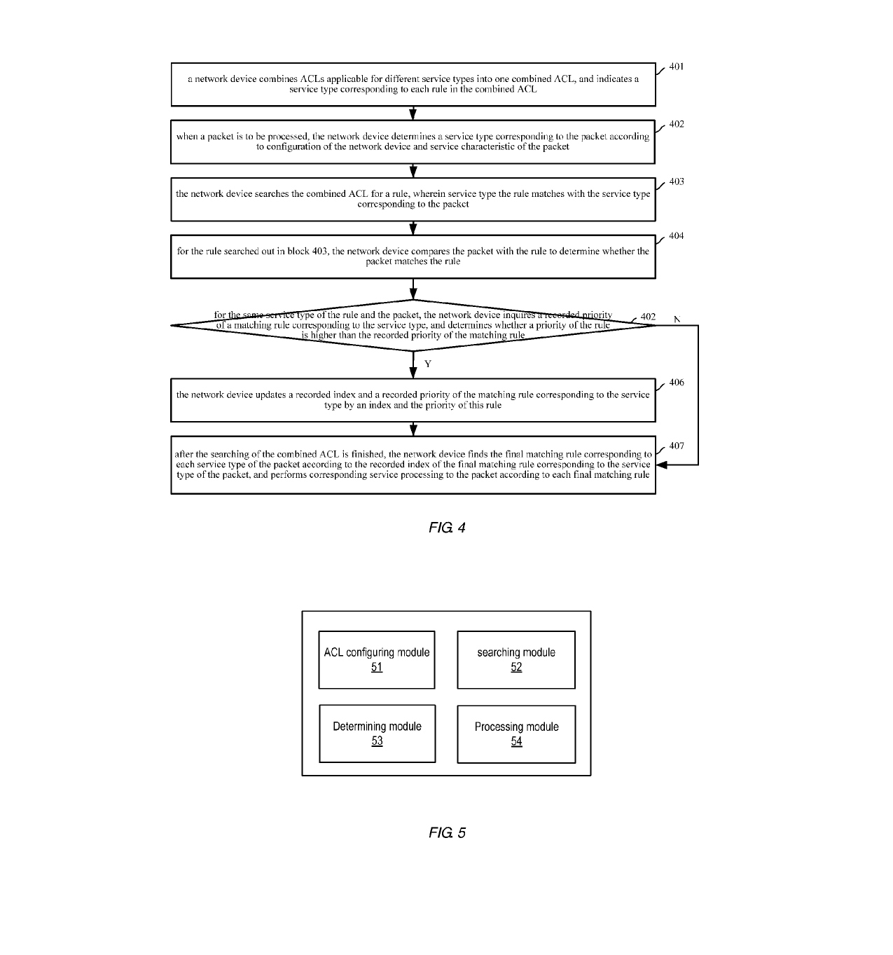

FIG. 4 shows a packet processing method according to various examples of the present disclosure. As shown in FIG. 4, the method includes the following.

At block 401, a network device combines ACLs applicable for different service types into one combined ACL, and indicates a service type corresponding to each rule in the combined ACL.

This block is similar to block 201 and is not repeated herein.

At block 402, when a packet is to be processed, the network device determines a service type corresponding to the packet according to configuration of the network device and service characteristic of the packet.

This block is similar to block 202 and is not repeated herein.

At block 403, the network device searches the combined ACL for a rule, wherein service type the rule matches with the service type corresponding to the packet.

In various examples, the service field of a rule is compared with the service field of the packet bit by bit. If the value of a bit in the service field of the rule is the same as that of the packet, it is determined that the rule corresponds to the same service type with the packet. For example, suppose that the service field of the packet is 1100, i.e. the service types corresponding to the packet include PBR and QoS. If the service field of a rule is 1000, 0100 or 1100, it is determined that the rule corresponds to the same service type with the packet.

At block 404, for the rule searched out in block 403, the network device compares the packet with the rule to determine whether the packet matches the rule. If the packet matches the rule, block 405 is executed.

In various examples, the network device may compare corresponding parts of a key of the packet with all fields of the rule. If corresponding parts completely matches the fields of the rule, it is determined that the packet matches the rule.

At block 405, for the same service type of the rule and the packet, the network device inquires a recorded priority of a matching rule corresponding to the service type, and determines whether a priority of the rule is higher than the recorded priority of the matching rule. If yes, block 406 is executed; otherwise, block 407 is executed.

For any service type to be performed to the packet, after the network device first time finds a matching rule, referred to as a first rule, the network device records an index and a priority of the first rule, and takes the first rule as a matching rule for the service type. Thereafter, if another matching rule is found, referred to as a second rule, it is determined whether the priority of the second rule is higher than the recorded priority of the first rule. If higher, the recorded index and priority of first rule are updated by the index and priority of the second rule, so as to ensure that the recorded priority is always the highest. After the searching of the ACL is finished, the rule corresponding to the finally recorded priority is taken as the final matching rule corresponding to the service type of the packet.

At block 406, the network device updates a recorded index and a recorded priority of the matching rule corresponding to the service type by an index and the priority of this rule.

At block 407, after the searching of the combined ACL is finished, the network device finds the final matching rule corresponding to each service type of the packet according to the recorded index of the final matching rule corresponding to the service type of the packet, and performs corresponding service processing to the packet according to each final matching rule.

It can thus be seen that after the searching of the combined ACL is finished, the network device obtains rules corresponding to all service types of the packet.

In view of the above flow illustrated in FIG. 4, for a packet on which multiple kinds of service processing are to be performed, it just requires searching the ACL for one time to obtain the matching rule corresponding to each service type.

Hereinafter an example is provided to describe the packet processing procedure.

Suppose that a router supports four kinds of services, i.e., PBR, QoS, filter and NAT. On the router, PBR and QoS are enabled.

Two ACLs are configured in the router.

A first ACL is as follows:
acl number 2000 name pbr
# It defines an ACL with index 2000 and the ACL is applicable for PBR service.
rule 10 permit ip source 10.1.0.0 0.0.255.255
# It defines a rule 10 which permits any packet whose source IP address is 10.1.0.0/16.
rule 20 permit ip source 10.2.0.0 0.0.255.255
# It defines a rule 20 which permits any packet whose source IP address is 10.2.0.0/16.
rule 30 deny ip source any destination any
# It defines a rule 30 which denies any packet whose source IP address is other than the above two addresses.
acl number 2001 name qos
# It defines an ACL with index 2001 applicable for QoS.
rule 40 permit ip source 10.1.0.0 0.0.255.255
# It defines a rule 40 which permits any packet whose IP address is 10.1.0.0/16.
rule 50 permit ip source 10.2.0.0 0.0.255.255
# It defines a rule 50 which permits any packet whose IP address is 10.2.0.0/16.
rule 60 deny ip source any destination any
# It defines a rule 60 which denies any packet whose source IP address is other than the above two addresses.

It can thus be seen that each rule has just one Data-Mask type field: source IP address.

The rules in the acl 2000 and ad 2001 are combined first. It can be found that rules 10 and 40 are the same, and rules 30 and 60 are the same. Therefore, rules 10 and 40 are combined into one rule, and rules 30 and 60 are combined into one rule. Thus, the previous six rules are combined into four rules.

Then a service field is defined for each rule in the combined ACL. Bit 3 of the service field represents whether the rule is applicable for PBR. Bit 2 of the service field represents whether the rule is applicable for QoS. Bit 1 of the service field represents whether the rule is applicable for packet filter. Bit 0 of the service field represents whether the rule is applicable for NAT.

The combined ACL is as shown in Table 1, wherein a rule with a smaller index has a higher priority.

TABLE 1
Combined ACL

| Index | Source IP/ | Service | |
|---|---|---|---|
| of rules | mask length | Field | Description |
| 1 | 10.1.0.0/16 | 1100 | Correspond to rule 10 and rule 40 |
| 2 | 10.2.0.0/16 | 1000 | Correspond to rule 20 |
| 3 | 10.3.0.0/16 | 0100 | Correspond to rule 50 |
| 4 | 0.0.0.0/0 | 1100 | Correspond to rule 30 and rule 60 |

Suppose that the router receives four packets, respectively are:
Packet 1, source IP address 10.1.1.1;
Packet 2, source IP address 10.2.1.1;
Packet 3, source IP address 10.3.1.1; and
Packet 4, source IP address 10.4.1.1.

Since PBR and QoS are enabled on the router, PBR and QoS service processing are to be performed to the four packets.

The searching of the ACL with respect to the four packets are as follows.

Before searching the ACL, an arrary hit_idx[4]={n1, n2, n3, n4} is respectively defined for the four packets, wherein n1, n2, n3 and n4 respectively denote an index of a matching rule corresponding the PBR, QoS, filter and NAT services. The array is initialized to hit_idx[4]={−1, −1, −1, −1}, indicating that the indexes of matching rules corresponding to the PBR, QoS, filter and NAT services are all −1, i.e., there are no matching rules.

For packet 1, the service field is 1100, the key is source IP address=10.1.1.1. The key is compared with the four rules in the combined ACL as shown in Table 1 in turn. The detailed procedure is as shown in Table 2.

| | Value of | Value of | |
|---|---|---|---|
| Index | hit_idx before | hit_idx after | |
| of Rules | comparison | comparison | Description |
| 1 | −1, −1, −1, −1 | 1, 1, −1, −1 | The source IP address of packet 1 matches |
| | | | the source IP address of rule 1. The service |
| | | | field of packet 1 completely matches the |
| | | | service field of rule 1, i.e., their bits |
| | | | representing PBR and QoS services are |
| | | | enabled. Thus, the indexes of matching |
| | | | rules corresponding to PBR and QoS |
| | | | services in the array hit_idx of packet 1 are |
| | | | updated by the index of rule 1. |
| 2 | 1, 1, −1, −1 | 1, 1, −1, −1 | The source IP address of packet 1 does not |
| | | | match the source IP address of rule 2. |
| | | | Therefore, the array hit_idx of packet 1 is |
| | | | not updated. |
| 3 | 1, 1, −1, −1 | 1, 1, −1, −1 | The source IP address of packet 1 does not |
| | | | match the source IP address of rule 3. |
| | | | Therefore, the array hit_idx of packet 1 is |
| | | | not updated. |
| 4 | 1, 1, −1, −1 | 1, 1, −1, −1 | The source IP address of packet 1 matches |
| | | | the source IP address of rule 4. The service |
| | | | field of packet 1 completely matches the |
| | | | service field of rule 4. But the priority of rule |
| | | | 4 is lower than rule 1. Therefore the array |
| | | | hit_idx of packet 1 is not updated. |

For packet 2, the service field is 1100, the key is source IP address=10.2.1.1.The key of packet 2 is compared with the four rules in the combined ACL as shown in Table 1 in turn. The detailed procedure is as shown in Table 3.

| | Value of | Value of | |
|---|---|---|---|
| Index | hit_idx before | hit_idx after | |
| of Rules | comparison | comparison | Description |
| 1 | −1, −1, −1, −1 | −1, −1, −1, −1 | The source IP address of packet 2 does |
| | | | not match the source IP address of rule |
| | | | 1. Thus, the array hit_idx of packet 2 is |
| | | | not updated. |
| 2 | −1, −1, −1, −1 | 2, −1, −1, −1 | The source IP address of packet 2 |
| | | | matches the source IP address of rule 2. |
| | | | The service field of packet 2 matches in |
| | | | part with the service field of rule 2, i.e., |
| | | | their bits representing PBR service are |
| | | | enabled. Thus, the index of matching rule |
| | | | corresponding to PBR service in the |
| | | | array hit_idx of packet 2 is updated with |
| | | | the index of rule 2. |
| 3 | 2, −1, −1, −1 | 2, −1, −1, −1 | The source IP address of packet 2 does |
| | | | not match the source IP address of rule |
| | | | 3. Therefore, the array hit_idx of packet 2 |
| | | | is not updated. |
| 4 | 2, −1, −1, −1 | 2, 4, −1, −1 | The source IP address of packet 2 |
| | | | matches the source IP address of rule 4. |
| | | | The service field of packet 2 completely |
| | | | matches the service field of rule 4, i.e., |
| | | | the bits representing PBR and QoS |
| | | | services are enabled. But the priority of |
| | | | rule 4 is lower than rule 2. Therefore the |
| | | | index of the matching rule corresponding |
| | | | to the PBR service in the array hit_idx of |
| | | | packet 2 is not updated, just the index of |
| | | | the matching rule corresponding to the |
| | | | QoS service is updated with the index of |
| | | | rule 4. |

For packet 3, the service field is 1100, the key is source IP address=10.3.1.1. The key of packet 3 is compared with the four rules in the combined ACL as shown in Table 1 in turn. The detailed procedure is as shown in Table 4.

| | Value of | Value of | |
|---|---|---|---|
| Index | hit_idx before | hit_idx after | |
| of Rules | comparison | comparison | Description |
| 1 | −1, −1, −1, −1 | −1, −1, −1, −1 | The source IP address of packet 3 does |
| | | | not match the source IP address of rule 1. |
| | | | Thus, the array hit_idx of packet 3 is not |
| | | | updated. |
| 2 | −1, −1, −1, −1 | −1, −1, −1, −1 | The source IP address of packet 3 does |
| | | | not match the source IP address of rule 2. |
| | | | Thus, the array hit_idx of packet 3 is not |
| | | | updated. |
| 3 | −1, −1, −1, −1 | −1, 3, −1, −1 | The source IP address of packet 3 |
| | | | matches the source IP address of rule 3. |
| | | | The service field of packet 3 matches in |
| | | | part with the service field of rule 3, i.e., |
| | | | their bits representing QoS service are |
| | | | enabled. Thus, the index of matching rule |
| | | | corresponding to QoS service in the array |
| | | | hit_idx of packet 3 is updated with the |
| | | | index of rule 3. |
| 4 | −1, 3, −1, −1 | 4, 3, −1, −1 | The source IP address of packet 3 |
| | | | matches the source IP address of rule 4. |
| | | | The service field of packet 3 completely |
| | | | matches the service field of rule 4, i.e., |
| | | | the bits representing PBR and QoS |
| | | | services are enabled. But the priority of |
| | | | rule 4 is lower than rule 3. Therefore the |
| | | | index of the matching rule corresponding |
| | | | to the QoS service in the array hit_idx of |
| | | | packet 3 is not updated, just the index of |
| | | | the matching rule corresponding to the |
| | | | PBR service is updated with the index of |
| | | | rule 4. |

For packet 4, the service field is 1100, the key is source IP address=10.4.1.1. The key of packet 4 is compared with the four rules in the combined ACL as shown in Table 1 in turn. The detailed procedure is as shown in Table 5.

| | Value of | Value of | |
|---|---|---|---|
| Index | hit_idx before | hit_idx after | |
| of Rules | comparison | comparison | Description |
| 1 | −1, −1, −1, −1 | −1, −1, −1, −1 | The source IP address of packet 4 does |
| | | | not match the source IP address of rule |
| | | | 1. Thus, the array hit_idx of packet 4 is |
| | | | not updated. |
| 2 | −1, −1, −1, −1 | −1, −1, −1, −1 | The source IP address of packet 4 does |
| | | | not match the source IP address of rule |
| | | | 2. Thus, the array hit_idx of packet 4 is |
| | | | not updated. |
| 3 | −1, −1, −1, −1 | −1, −1, −1, −1 | The source IP address of packet 4 does |
| | | | not match the source IP address of rule |
| | | | 3. Thus, the array hit_idx of packet 4 is |
| | | | not updated. |
| 4 | −1, −1, −1, −1 | 4, 4, −1, −1 | The source IP address of packet 4 |
| | | | matches the source IP address of rule 4. |
| | | | The service field of packet 4 completely |
| | | | matches the service field of rule 4, i.e., |
| | | | the bits representing PBR and QoS |
| | | | services are enabled. Therefore the |
| | | | indexes of the matching rules |
| | | | corresponding to the PBR and QoS |
| | | | services in the array hit_idx of packet 4 |
| | | | are updated with the index of rule 4. |

According to the searched results shown in the Tables 2˜5, service processing is performed as follows. For packet 1, PBR and QoS service processing are performed according to rule 1. For packet 2, PBR service processing is performed according to rule 2 and QoS processing is performed according to rule 4. For packet 3, PBR processing is performed according to rule 4 and QoS processing is performed according to rule 3. For packet 4, PBR and QoS processing are performed according to rule 4.

FIG. 5 shows a packet processing packet according to the present disclosure. As shown in FIG. 5, the apparatus includes: an ACL configuring module 51, a searching module 52, a determining module 53 and a processing module 54; wherein
the ACL configuring module 51 combines ACLs applicable for different service types into one combined ACL, and indicates a service type corresponding to each rule in the combined ACL;
the searching module 52 determines a service type corresponding to a packet to be processed; determines whether the packet matches a current rule in the combined ACL, if the packet matches the current rule in the combined ACL, determines whether the current rule and packet correspond to the same service type, if the current rule and the packet correspond to the same service type, determines whether a priority of the current rule is higher than a recorded priority of a matching rule corresponding to the service type, if the priority of the current rule is higher than the recorded priority, updates the recorded priority with the priority of the current rule and takes the current rule as the matching rule corresponding to the service type;
the determining module 53 determines whether the current rule is a last rule in the combined ACL, if the current rule is the last rule in the combined ACL, triggers the processing module 54 to process the packet according to the matching rule corresponding to the service type, if the current rule is not the last rule in the combined ACL, takes a next rule in the combined ACL as the current rule, and trigger operations of the searching module 52; and
the processing module 54 processes the packet according to the matching rule in response to the determining module 53 determining the current rule is the last rule in the combined ACL.

In various examples, the ACL configuring module 51 configures a service field for each rule in the combined ACL, wherein a value of each bit in the service field indicates whether the rule is applicable for one service type. If there are same ACL rules applicable for several service types, the ACL configuring module 51 combines these ACL rules into one ACL rule, and indicates all service types applicable for this rule.

In various examples, the searching module 52 configures a service field for the packet to indicate the service type corresponding to the packet.

The searching module 52 may determine whether the current rule and the packet correspond to the same service type through comparing the service fields of the current rule and the packet. If the service fields of the current rule and the packet have the same enabled bit, the searching module 52 determines that the current rule and the packet correspond to the same service type.

In various examples, if the current rule and the packet have two or more same service types, with respect to each of the same service types, the searching module 52 respectively performs the operations of: determining whether the priority of the current rule is higher than the recorded priority of the matching rule corresponding to the service type, if the priority of the current rule is higher than the recorded priority, updating the recorded priority with the priority of the current rule and taking the current rule as the matching rule corresponding to the service type.

In various examples, the searching module 52 configures an array for recording indexes of matching rules corresponding to service types of the packet, wherein each element of the array corresponds to one service type. The elements in the array may be configured with invalid initial values such as −1, indicating that there are no matching rules yet.

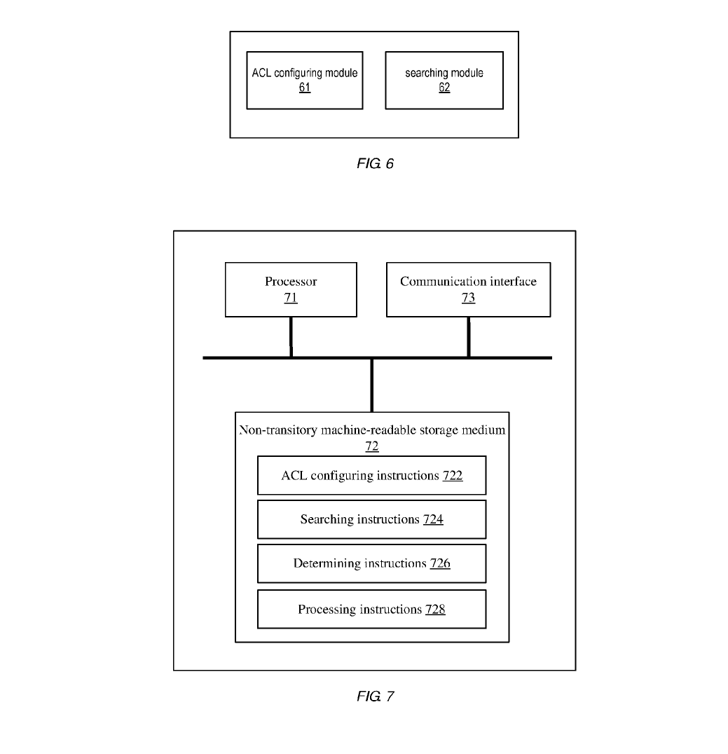

FIG. 6 shows a packet processing packet according to the present disclosure. As shown in FIG. 6, the apparatus includes: an ACL configuring module 61 and a searching module 62; wherein
the ACL configuring module 61 combines ACLs applicable for different service types into one combined ACL, and indicates a service type corresponding to each rule in the combined ACL; and
the searching module 62 determines, when service processing is to be performed to a packet, service types corresponding to the packet; searches the combined ACL for a rule, wherein the service type applicable for the rule matches one of the service types corresponding to the packet; determines whether the packet matches the rule; determines the rule as a matching rule corresponding to the service type of the rule; after the searching of the ACL is finished, obtains rules corresponding to the service types corresponding to the packet, and performs corresponding service processing to the packet according to the rules.

The searching module 62 compares a key of the packet with a corresponding field of the rule to determine whether the packet matches the rule. For each matching service type, the searching module 62 determines whether a priority of the rule is higher than a recorded priority of a matching rule corresponding to the service type. If yes, the searching module 62 updates the recorded index and priority of the matching rule by the index and priority of the current rule.

The modules shown in FIG. 5 and FIG. 6 may be implemented by a programmable device, such as central processing unit (CPU), Field Programmable Gate Array (FPGA), etc.

The apparatus shown in FIG. 5 and FIG. 6 may be any device using ACL.

FIG. 7 shows another example of a packet processing apparatus according to the present disclosure. As shown in FIG. 7, the apparatus includes a processor 71, non-transitory machine readable storage medium 72, and a communication interface 73;

wherein
the communication interface 73 receives a packet to be processed;
the non-transitory machine readable storage medium 72 stores instructions which are executable by the processor 71, the instructions include:
ACL configuring instructions 722, to combine ACLs applicable for different service types into one combined ACL, and indicate a service type corresponding to each rule in the combined ACL;
searching instructions 724, to determine a service type corresponding to a packet to be processed; determine whether the packet matches a current rule in the combined ACL, if the packet matches the current rule in the combined ACL, determine whether the current rule and packet correspond to the same service type, if the current rule and the packet correspond to the same service type, determine whether a priority of the current rule is higher than a recorded priority of a matching rule corresponding to the service type, if the priority of the current rule is higher than the recorded priority, update the recorded priority with the priority of the current rule and take the current rule as the matching rule corresponding to the service type;
determining instructions 726, to determine whether the current rule is a last rule in the combined ACL, if the current rule is the last rule in the combined ACL, trigger processing instructions 728 to process the packet according to the matching rule corresponding to the service type, if the current rule is not the last rule in the combined ACL, take a next rule in the combined ACL as the current rule, and trigger operations of the searching instructions 724; and
the processing instructions 728, to process the packet according to the matching rule in response to the determining instructions 726 determining the current rule is the last rule in the combined ACL.

In an example, the ACL may be stored in the non-transitory machine readable storage medium 72 or another non-transitory machine readable storage medium.

It should be noted that, the packet processing apparatus shown in FIG. 7 is merely an example. The apparatus may be implemented via other structures different from the above example. For example, an application specific integrated circuit (ASIC) may be utilized to implement the operations realized by the above instructions. In addition, the number of the processor may be one or more. If there are multiple processors, the multiple processors cooperate to read and execute the above instructions. Therefore, the detailed structure of the packet processing apparatus is not intended to be restricted in the present disclosure.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What is claimed is:

1. A method for processing a packet, comprising:
determining a service type corresponding to a packet to be processed;
determining whether the packet matches a current rule in a combined access control list (ACL), wherein the combined ACL includes rules corresponding to different service types;
if the packet matches the current rule, determining whether the current rule and the packet correspond to the same service type;
if the current rule and the packet correspond to the same service type, determining whether a priority of the current rule is higher than a recorded priority of a matching rule corresponding to the service type;
if the priority of the current rule is higher than the recorded priority, updating the recorded priority with the priority of the current rule, and taking the current rule as the matching rule corresponding to the service type;
determining whether the current rule is a last rule in the combined ACL, if the current rule is the last rule in the combined ACL, processing the packet according to the matching rule corresponding to the service type.

2. The method of claim 1, further comprising:
configuring a first service field for the packet, to indicate the service type corresponding to the packet; wherein each bit of the first service field corresponds to one service type; and
configuring a second service field for each rule in the combined ACL, wherein each bit of the second service field indicates whether the rule is applicable for one service type.

3. The method of claim 2, wherein the determining whether the current rule and the packet correspond to the same service type comprises:
comparing the first service field and the second service field, if the first service field and the second service field have a same enabled bit, determining the current rule and the packet correspond to the same service type.

4. The method of claim 1, wherein the current rule and the packet have two or more same service types, with respect to each of the same service types, performing the operation of determining whether the priority of the current rule is higher than the recorded priority of the matching rule corresponding to the service type, if the priority of the current rule is higher than the recorded priority, updating the recorded priority with the priority of the current rule and taking the current rule as the matching rule corresponding to the service type.

5. The method of claim 1, further comprising:
configuring an array for recording an index of the matching rule corresponding to the service type of the packet, wherein each element of the array corresponds to one service type.

6. The method of claim 5, further comprising:
if the priority of the current rule is higher than the recorded priority, updating an index of the matching rule recorded in the array with an index of the current rule.

7. The method of claim 1, wherein the service type includes any one of: policy based routing (PBR), quality of service (QoS), packet filter, and network address translation (NAT).

8. An apparatus for processing a packet, comprising:
an ACL configuring module, to combine access control lists (ACLs) applicable for different service types into one combined ACL, and indicates a service type corresponding to each rule in the combined ACL;
a searching module, to determine a service type corresponding to a packet to be processed; determines whether the packet matches a current rule in the combined ACL, if the packet matches the current rule in the combined ACL, determine whether the current rule and packet correspond to the same service type, if the current rule and the packet correspond to the same service type, determine whether a priority of the current rule is higher than a recorded priority of a matching rule corresponding to the service type, if the priority of the current rule is higher than the recorded priority, update the recorded priority with the priority of the current rule and take the current rule as the matching rule corresponding to the service type;
a determining module, to determine whether the current rule is a last rule in the combined ACL, if the current rule is the last rule in the combined ACL, trigger the processing module to process the packet according to the matching rule corresponding to the service type, if the current rule is not the last rule in the combined ACL, take a next rule in the combined ACL as the current rule, and trigger operations of the searching module; and
the processing module, to process the packet according to the matching rule in response to the determining module determining the current rule is the last rule in the combined ACL.

9. The apparatus of claim 8, wherein
the searching module is to configure a first service field for the packet, to indicate the service type corresponding to the packet; wherein each bit of the first service field corresponds to one service type; and
the ACL configuring module is to configure a second service field for each rule in the combined ACL, wherein each bit of the second service field indicates whether the rule is applicable for one service type.

10. The apparatus of claim 9, wherein the searching module is to compare the first service field and the second service field, if the first service field and the second service field have a same enabled bit, determine that the current rule and the packet correspond to the same service type.

11. The apparatus of claim 8, wherein the current rule and the packet have two or more same service types, with respect to each of the same service types, the searching module performs the operation of determining whether the priority of the current rule is higher than the recorded priority of the matching rule corresponding to the service type, if the priority of the current rule is higher than the recorded priority, updating the recorded priority with the priority of the current rule and taking the current rule as the matching rule corresponding to the service type.

12. The apparatus of claim 8, wherein the searching module configures an array for recording an index of the matching rule corresponding to the service type of the packet, wherein each element of the array corresponds to one service type.

13. The apparatus of claim 12, wherein the searching module updates, if the priority of the current rule is higher than the recorded priority, an index of the matching rule recorded in the array with an index of the current rule.

14. An apparatus for processing a packet, comprising:
a communication interface, to receive a packet to be processed;
a processer;
non-transitory machine readable storage medium, storing instructions which are executable by the processor, the instructions include:
ACL configuring instructions, to combine ACLs applicable for different service types into one combined ACL, and indicate a service type corresponding to each rule in the combined ACL;
searching instructions, to determine a service type corresponding to a packet to be processed; determine whether the packet matches a current rule in the combined ACL, if the packet matches the current rule in the combined ACL, determine whether the current rule and packet correspond to the same service type, if the current rule and the packet correspond to the same service type, determine whether a priority of the current rule is higher than a recorded priority of a matching rule corresponding to the service type, if the priority of the current rule is higher than the recorded priority, update the recorded priority with the priority of the current rule and take the current rule as the matching rule corresponding to the service type;
determining instructions, to determine whether the current rule is a last rule in the combined ACL, if the current rule is the last rule in the combined ACL, trigger processing instructions to process the packet according to the matching rule corresponding to the service type, if the current rule is not the last rule in the combined ACL, take a next rule in the combined ACL as the current rule, and trigger operations of the searching instructions; and
the processing instructions, to process the packet according to the matching rule in response to the determining instructions determining the current rule is the last rule in the combined ACL.
